(19) United States
(12) Patent Application Publication
(10) Pub. No.: US 2013/0019912 A1
(43) Pub. Date: Jan. 24, 2013

(54) Umbrella for Providing Shade

(71) Applicants: Frank Kennedy, Las Vegas, NV (US); Damie Kennedy, Las Vegas, NV (US)

(72) Inventors: Frank Kennedy, Las Vegas, NV (US); Damie Kennedy, Las Vegas, NV (US)

(21) Appl. No.: 13/188,461

(22) Filed: Jul. 22, 2011

(51) Int. Cl. A45B 25/00; F16B 2/10

(52) U.S. Cl. 135/16

(57) ABSTRACT

An apparatus comprises an umbrella canopy comprising a central point and a canopy material being disposed about the central point. A support rod comprises a first end and a second end. The first end is joined to the central point. The support rod is configured to be flexible to be bent in a plurality of directions and to be supportive of the umbrella canopy at a bent direction. A securing device is joined to the second end. The securing device is operable to secure the apparatus to a fixed structure where the support rod supports the umbrella canopy at the bent direction relative to the fixed structure.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to outdoor accessories. More particularly, the invention relates to a device to shade items from the sun.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many people enjoy being outdoors in the sun, for example, without limitation, in the pool, in the garden, or at the park, and when outdoors people often keep a cool beverage or other types of refreshments nearby. However, the heat of the sun can be detrimental to these refreshments, for example, without limitation, by melting ice or warming cold food or beverages. That same heat can also damage many of the other items people use outdoors such as, but not limited to, sunscreen, lotions, portable electronics, etc. Traditional means for protecting items from the sun include, without limitation, ice chests, coolers, placing items in shaded locations, etc.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1E illustrate an exemplary shading device, in accordance with an embodiment of the present invention. FIG. 1A is a side view of the device in an open position. FIG. 1B is a side view of the device in a closed position. FIG. 1C is a front perspective view of a clamp. FIG. 1D is a side view of a two-piece hosting ring, and FIG. 1E is a side perspective view of the device clamped to a table.

Unless otherwise indicated illustrations in the figures are not necessarily drawn to scale.

### SUMMARY OF THE INVENTION

To achieve the forgoing and other objects and in accordance with the purpose of the invention, a variety umbrellas for providing shade are described.

In one embodiment an apparatus comprises an umbrella canopy comprising a central point and a canopy material being disposed about the central point. A support rod comprises a first end and a second end. The first end is joined to the central point. The support rod is configured to be flexible to be bent in a plurality of directions and to be supportive of the umbrella canopy at a bent direction. A securing device is joined to the second end. The securing device is operable to secure the apparatus to a fixed structure where the support rod supports the umbrella canopy at the bent direction relative to the fixed structure. Another embodiment further comprises a plurality of ribs joined to the canopy material. The plurality of ribs is configured to support the canopy material radially about the central point. Yet another embodiment further comprises a plurality of stretchers being configured to be rotatably joined to the plurality of ribs and slidably joined to the support rod where slidable motion of the plurality of stretchers is operable to open and collapse the umbrella canopy. Still another embodiment further comprises a first ring being joined to the plurality of stretchers and being slidably joined to the support rod. Another embodiment further comprises a second ring being fixedly joined proximate the first end and a tension spring being joined between the first ring and the second ring where a tension on the tension spring is operable to move the first ring in a direction to open the umbrella canopy. Yet another embodiment further comprises a spring-loaded stopper being configured to retain the first ring in a position where the umbrella canopy is collapsed. Still another embodiment further comprises a collar surrounding the joining location of the securing device and the second end. In another embodiment the securing device comprises a clamp. In yet another embodiment the clamp comprises a first half and a second half pivotally joined together. In still another embodiment the clamp further comprises a spring mechanism being configured to urge the first half and the second half to a closed position. In another embodiment the first half and the second half each comprise a handle and a clamping area. In yet another embodiment the first half and the second half each further comprise a sleeve being joined to the handle. In still another embodiment the first half and the second half each further comprise a grooved coating on the clamping area.

In another embodiment an apparatus comprises an umbrella canopy comprising a central point and a canopy material being disposed about the central point, means for radially supporting the canopy material about the central point, means for supporting the umbrella canopy and the radial supporting means, the supporting means being configured for bending in a plurality of directions and for supporting the umbrella canopy at a bent direction, means for slidably joining to the support rod, means being joined to the radial supporting means and joined to the slidably joining means for opening and collapsing the umbrella canopy, means for moving the opening and collapsing means in a direction to open the umbrella canopy, means for retaining the opening and collapsing means a position where the umbrella canopy is collapsed, and means for securing the apparatus to a fixed structure where the supporting means supports the umbrella canopy at the bent direction relative to the fixed structure.

In another embodiment an apparatus comprises an umbrella canopy comprises a central point and a canopy material being disposed about the central point. A plurality of ribs is joined to the canopy material. The plurality of ribs is configured to support the canopy material radially about the central point. A support rod comprises a first end and a second end. The first end being is to the central point. The support rod is configured to be flexible to be bent in a plurality of directions and to be supportive of the umbrella canopy at a bent direction. A first ring is slidably joined to the support rod. A plurality of stretchers is configured to be rotatably joined to the plurality of ribs and joined to the first ring where slidable motion of the plurality of stretchers is operable to open and collapse the umbrella canopy. A second ring is fixedly joined proximate the first end. A tension spring is joined between the first ring and the second ring where a tension on the tension spring is operable to move the first ring in a direction to open the umbrella canopy. A spring-loaded stopper is configured to retain the first ring in a position where the umbrella canopy is collapsed. A clamp is joined to the second end. The clamp is operable to secure the apparatus to a fixed structure where the support rod supports the umbrella canopy at the bent direction relative to the fixed structure. In another embodiment the clamp comprises a first half and a second half pivotally joined together. In yet another embodiment the clamp further comprises a spring mechanism being configured to urge the first half and the second half to a closed position. In still another embodiment the first half and the second half each comprise a handle and a clamping area. In another embodiment the first half and the second half each further comprise a sleeve being joined to the handle. In yet another embodiment the first half and the second half each further comprise a grooved coating on the clamping area.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention provides a small umbrella for provision of shade upon items such as, but not limited to, foods, beverages and personal goods while in outdoor environments. Many practical embodiments can help preserve and protect personal items from damages and/or tangible depreciation by providing a strategic shield from sunlight and heat.

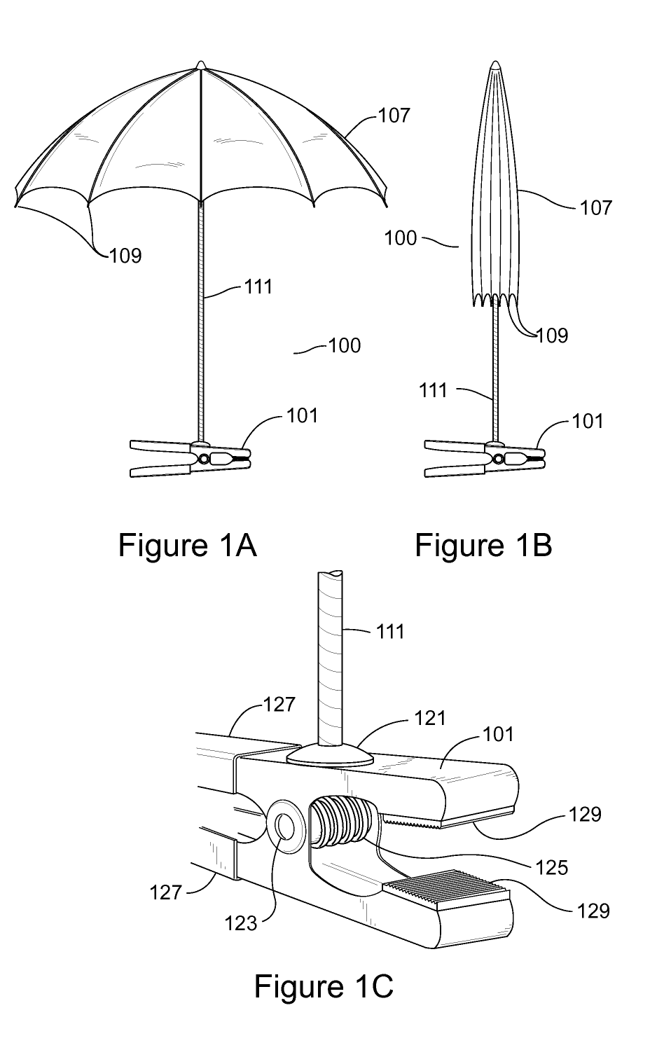

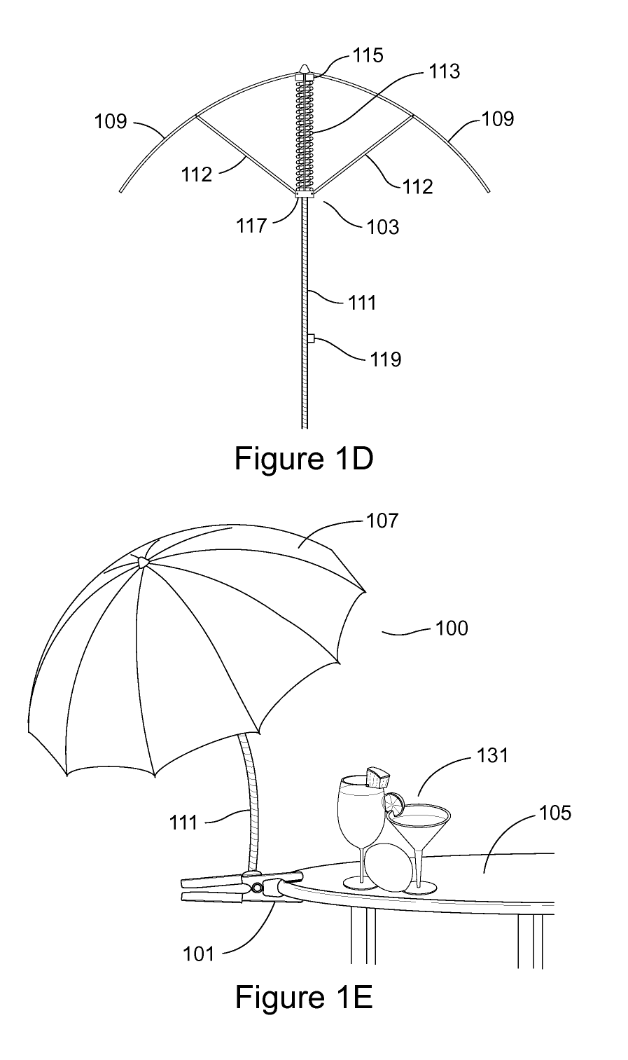

FIGS. 1A through 1E illustrate an exemplary shading device 100, in accordance with an embodiment of the present invention. FIG. 1A is a side view of device 100 in an open position. FIG. 1B is a side view of device 100 in a closed position. FIG. 1C is a front perspective view of a clamp 101. FIG. 1D is a side view of a two-piece hosting ring 103, and FIG. 1E is a side perspective view of device 100 clamped to a table 105. In the present embodiment, shading device 100 comprises a small-sized umbrella awning or canopy 107, and collapsible ribs 109 that support awning 107. Awning 107 is featured upon a flexible support rod 111, and clamp 101 for mounting device 100 is featured on the opposite end of rod 111. Awning 107 is made of a nylon material with an extended diameter of approximately twenty inches (20″). However, in some alternate embodiments, awnings can be implemented in smaller or larger sizes and in various different shapes such as, but not limited to, squares, triangles, ovals, etc. Furthermore, it is contemplated that awnings in some alternate embodiments can be produced of a multiplicity of suitable materials, including, but not limited to, nylon, nylon packcloth, polyester, cotton, canvas, plastic, etc.

In the present embodiment, ribs 109 of awning 107 are collapsible and of an approximate ten inches (10″) in extended length; however, some alternate embodiments may comprise ribs of various different lengths depending on the size and shape of the awning that the ribs are supporting. In the present embodiment, ribs 109 are made of a stainless steel material. However, in some alternate embodiments, the ribs can be made of various different lightweight materials of adequate durability including, but not limited to, aluminum, other metals, graphite, plastic, etc. In the present embodiment, referring to FIG. 1D, ribs 109 are connected to stretchers 112 that extend from two-piece hosting ring 103 on rod 111. A tension spring 113 is between a fixed upper ring 115 and a finger grip 117 that engages spring 113. Finger grip 117 is large enough to grip and curves outward. Finger grip 117 may also be textured or have a rubberized coating to help a user grasp finger grip 117 even if their hands are wet. In some alternate embodiments, finger grips may be implemented in various different shapes and sizes. In the present embodiment, stretchers 112 hold ribs 109 in the open position when spring 113 is in an unengaged, resting state, as shown by way of example in FIG. 1D. To close device 100, the user pulls finger grip 117 down rod 111, engaging spring 113 and collapsing stretchers 112 and ribs 109, until finger grip 117 reaches a spring-loaded stopper 119. Stopper 119 holds finger grip 117 in the closed position. To reopen device 100, the user presses stopper 119 to release finger grip 117 so that spring 113 retracts to pull stretchers 112 up and press open ribs 109. Some embodiments may also comprise an upper stopper to securely hold finger grip 117 in the open position. Those skilled in the art will readily recognize, in light of and in accordance with the teachings of the present invention, that some alternate embodiments may comprise various different means for opening and closing the awning. For example, without limitation, in some alternate embodiments, the spring of the hosting ring may be at rest in the closed position. The user opens these embodiments by pushing the top ring of the two-piece hosting ring up to a stopper near the top of the support rod. Other alternate embodiments may comprise manual rather than spring activated means. Other alternate embodiments may comprise various different mechanisms such as, but not limited to, pulleys, rubber bands, different types of spring activated mechanisms, ratcheting mechanisms, cranks, etc. Yet other alternate embodiments may be implemented with awnings that do not collapse.

In the present embodiment, hosting ring 103 fits upon flexible support rod 111, which is made of stainless steel material in a gooseneck format. Rod 111 measures approximately eighteen inches in length by one-quarter of one inch in diameter (18″×¼″). Rod 111 is flexible and enables awing 107 to be moved to follow the sun in order to generally ensure thorough shade throughout day. In some alternate embodiments, the flexible support rod can be made in various different formats, including, but not limited to, plastic coated bendable wire or flexible piping, and these support rods can be made of various different materials, such as but not limited to aluminum, various other metals, plastic, a combination of materials, etc. In addition, it is contemplated that flexible support rods in some alternate embodiments can be made in various lengths and diameters and may be able to bend to various maximum radii with various different tensions. Other alternate embodiments may be implemented with a rigid, nonadjustable support rod.

In the present embodiment, the bottom endpoint of rod 111 comprises spring-loaded clamp 101. Referring to FIG. 1C, rod 111 connects to the top surface clamp 101, and a durable collar 121 surrounds the connection point where shaft 111 meets clamp 101. Some alternate embodiments may be implemented without a collar at this connection point. In the present embodiment, clamp 101 measures approximately four and one-half inches in length by one inch in width (4½×1″); however, some alternate embodiments may comprise clamps that are larger or smaller. In the present embodiment, clamp 101 is made up of two halves that connect and pivot near the center of clamp 101 by a shaft 123. A spring 125 wraps around shaft 123 and holds clamp 101 in the closed position until a user squeezes handles 127. Each handle 127 features a sleeve made of a lightweight, pliable material such as, but not limited to, plasticized polyvinyl chloride (p-PVC), vinyl or rubber for added grip; however, the clamps in some alternate embodiments may not comprise sleeves on the handles. In the present embodiment, the clamping area of each piece of clamp 101 also features a plasticized polyvinyl chloride (p-PVC) coating 129. Coating 129 is grooved to create friction to generally ensure a good grip. Coating 129 also protects the surface to which device 100 is clamped. It is contemplated that some alternate embodiments may comprise grip area coatings of various different materials such as, but not limited to rubber, vinyl or plastic and of various different types. For example, without limitation, in some alternate embodiments the coating may have various different textures or no texture. Other alternate embodiments may be implemented without grip area coatings. In the preset embodiment, clamp 101 can be made of various different materials, including, but not limited to, stainless steel, aluminum and high-density polyethylene (HDPE). Those skilled in the art will readily recognize, in light of and in accordance with the teachings of the present invention, that some alternate embodiments may implement a multiplicity of suitable attachment means other than spring-loaded clamps, including, but not limited to, other types of clamps, suction cups, weighted bases, stakes, hooks, adhesives, hook and loop material, straps, screws, bolts, etc. Other alternate embodiments may be permanently attached to a support structure.

Referring to FIG. 1E, in typical use of the present embodiment, a user may easily apply shading device 100 upon table 105 by use of clamp 101. The user may then open umbrella awning 107. Flexible rod 111 can then be maneuvered to place awning 107 in position to provide shade upon a desired and selected area, for example without limitation, refreshments 131. Should movement of the sun alter the position of the shade produced by device 100, the user may simply adjust awning 107 by repositioning rod 111, typically without removing or remounting clamp 101. Shading device 100 helps protect the desired serving temperature of beverages and other consumables by generally preventing direct sunlight from striking and altering these items. In addition device 100 helps to generally prevent the ice in beverages from rapidly melting, which may make these beverages taste watered-down, and substantially delays the melting of various food items. It is contemplated that shading device 100 may be attached to a multiplicity of suitable support structures such as, but not limited to chairs, benches, poles, ice chests, fences, trays, rails, automobiles, boats, etc. Furthermore, shading device 100 may be used to shade a wide variety of items including, but not limited to, food, beverages, lotions, sunscreens, bug repellants, electronic devices, books, magazines, etc. Shading device 100 can be used in practically any environment including, without limitation, swimming pools, beaches, picnics, tailgate parties, outdoor sporting events, concerts, other types of outdoor events, resorts, cruise ships, etc. Furthermore, device 100 can be used by many types of users such as, but not limited to, gardeners, sunbathers, anglers, hunters, sports fans, vacationers, boaters, etc.

Those skilled in the art will readily recognize, in light of and in accordance with the teachings of the present invention, that shading devices in alternate embodiments may comprise a multiplicity of suitable features and additional components such as, but not limited to, dual canopies, a built-in oval airflow system to enhance wind tolerance, an auto-release function to resist its knockdown due to winds in which this auto-release function may be made capable to withstand various force pressures, telescoping support rods, automatic open and close functions, lights, fans, solar panels to power small electronic items, wrist straps, etc. Furthermore, many practical embodiments can be made in various different colors with various different patterns and designs including, with out limitation, various images and/or logos, which may or may not be of registered trademark and/or copyright status on the awning or the clamp. In one alternate embodiment, a shading device is made for commercial use in which the awning bears a number or other such identifying mark for the purpose of identifying customer serving areas by staff, for example, without limitation, in a resort environment, patio dining environment, cruise ship environment, etc. This identifying mark can be placed on the awning by various different means such as, but not limited to, stitch, screen-printing, painting, etc.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a shading device according to the present invention will be apparent to those skilled in the art. The invention has been described above by way of illustration, and the specific embodiments disclosed are not intended to limit the invention to the particular forms disclosed. For example, the particular implementation of the support rod may vary depending upon the particular type of adjustment means used. The support rods described in the foregoing were directed to flexible implementations; however, similar techniques are to provide support rods that can adjust in various different ways. For example without limitation, some alternate embodiments may comprise a curved or angled rigid rod that rotates about its connection point with the clamp or a straight rigid rod that is connected to the clamp by a ball and socket joint that allows for a wide range of motion. Non-flexible implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
an umbrella canopy comprising a central point and a canopy material being disposed about said central point;
a support rod comprising a first end and a second end, said first end being joined to said central point, said support rod being configured to be flexible to be bent in a plurality of directions and to be supportive of said umbrella canopy at a bent direction; and
a securing device being joined to said second end, said securing device being operable to secure the apparatus to a fixed structure where said support rod supports said umbrella canopy at the bent direction relative to the fixed structure.

2. The apparatus as recited in claim 1, further comprising a plurality of ribs joined to said canopy material, said plurality of ribs being configured to support said canopy material radially about said central point.

3. The apparatus as recited in claim 2, further comprising a plurality of stretchers being configured to be rotatably joined to said plurality of ribs and slidably joined to said support rod where slidable motion of said plurality of stretchers is operable to open and collapse said umbrella canopy.

4. The apparatus as recited in claim 3, further comprising a first ring being joined to said plurality of stretchers and being slidably joined to said support rod.

5. The apparatus as recited in claim 4, further comprising a second ring being fixedly joined proximate said first end and a tension spring being joined between said first ring and said second ring where a tension on said tension spring is operable to move said first ring in a direction to open said umbrella canopy.

6. The apparatus as recited in claim 4, further comprising a spring-loaded stopper being configured to retain said first ring in a position where said umbrella canopy is collapsed.

7. The apparatus as recited in claim 1, further comprising a collar surrounding the joining location of said securing device and said second end.

8. The apparatus as recited in claim 1, in which said securing device comprises a clamp.

9. The apparatus as recited in claim 8, in which said clamp comprises a first half and a second half pivotally joined together.

10. The apparatus as recited in claim 9, in which said clamp further comprises a spring mechanism being configured to urge said first half and said second half to a closed position.

11. The apparatus as recited in claim 9, in which said first half and said second half each comprise a handle and a clamping area.

12. The apparatus as recited in claim 11, in which said first half and said second half each further comprise a sleeve being joined to said handle.

13. The apparatus as recited in claim 11, in which said first half and said second half each further comprise a grooved coating on said clamping area.

14. An apparatus comprising:
an umbrella canopy comprising a central point and a canopy material being disposed about said central point;
means for radially supporting said canopy material about said central point;
means for supporting said umbrella canopy and said radial supporting means, said supporting means being configured for bending in a plurality of directions and for supporting said umbrella canopy at a bent direction;
means for slidably joining to said support rod;
means being joined to said radial supporting means and joined to said slidably joining means for opening and collapsing said umbrella canopy;
means for moving said opening and collapsing means in a direction to open said umbrella canopy;
means for retaining said opening and collapsing means a position where said umbrella canopy is collapsed; and
means for securing the apparatus to a fixed structure where said supporting means supports said umbrella canopy at the bent direction relative to the fixed structure.

15. An apparatus comprising:
an umbrella canopy comprising a central point and a canopy material being disposed about said central point;
a plurality of ribs being joined to said canopy material, said plurality of ribs being configured to support said canopy material radially about said central point;
a support rod comprising a first end and a second end, said first end being joined to said central point, said support rod being configured to be flexible to be bent in a plurality of directions and to be supportive of said umbrella canopy at a bent direction;
a first ring being slidably joined to said support rod;
a plurality of stretchers being configured to be rotatably joined to said plurality of ribs and joined to said first ring where slidable motion of said plurality of stretchers is operable to open and collapse said umbrella canopy;
a second ring being fixedly joined proximate said first end;
a tension spring being joined between said first ring and said second ring where a tension on said tension spring is operable to move said first ring in a direction to open said umbrella canopy;
a spring-loaded stopper being configured to retain said first ring in a position where said umbrella canopy is collapsed; and
a clamp being joined to said second end, said clamp being operable to secure the apparatus to a fixed structure where said support rod supports said umbrella canopy at the bent direction relative to the fixed structure.

16. The apparatus as recited in claim 15, in which said clamp comprises a first half and a second half pivotally joined together.

17. The apparatus as recited in claim 16, in which said clamp further comprises a spring mechanism being configured to urge said first half and said second half to a closed position.

18. The apparatus as recited in claim 16, in which said first half and said second half each comprise a handle and a clamping area.

19. The apparatus as recited in claim 18, in which said first half and said second half each further comprise a sleeve being joined to said handle.

20. The apparatus as recited in claim 18, in which said first half and said second half each further comprise a grooved coating on said clamping area.
